(19) United States
(12) Patent Application Publication
(10) Pub. No.: US 2014/0325673 A1
(43) Pub. Date: Oct. 30, 2014

(54) LIVE BROADCAST CONTENT PROTECTION BASED ON WATERMARKING

(71) Applicant: VERANCE CORPORATION, San Diego, CA (US)

(72) Inventor: Rade Petrovic, San Diego, CA (US)

(73) Assignee: VERANCE CORPORATION, San Diego, CA (US)

(21) Appl. No.: 14/262,460

(22) Filed: Apr. 25, 2014

Related U.S. Application Data
(60) Provisional application No. 61/816,118, filed on Apr. 25, 2013.

(51) Int. Cl. G06F 21/16

(52) U.S. Cl. CPC G06F 21/16; G06F 2221/0733
USPC 726/27

(57) ABSTRACT

Techniques for thwarting piracy of real-time content such as broadcast streams are described. In one technique, when portions of a real-time content is received at a user device, the device embeds a particular code in the received content that associates the real-time content to that user device. When further portions of the real-time content that has one or more codes is received at the user device, the device determines if the particular code matches the one or more codes that are incorporated into the real-time content, and if a match if found, one of more actions is initiated at the user device to thwart further dissemination of the real-time content. The initiated actions can interfere with the playback of the real-time content or provide warning messages, and thus eliminate or discourage the use of the user device as a source of real-time content piracy.

### CROSS REFERENCE TO RELATED APPLICATIONS

This patent application claims the benefit of U.S. Provisional Patent Application No. 61/816,118, filed Apr. 25, 2013. The entire content of the before-mentioned patent application is incorporated by reference as part of the disclosure of this application.

### FIELD OF INVENTION

The present application generally relates to multimedia content management, and more specifically to methods, devices and computer program products to thwart unauthorized usage of multimedia content.

### BACKGROUND

A multimedia content, such as an audiovisual content, often consists of a series of related images which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc. In some scenarios, such a multimedia content, or portions thereof, may contain only one type of content, including, but not limited to, a still image, a video sequence and an audio clip, while in other scenarios, the multimedia content, or portions thereof, may contain two or more types of content.

Watermarking has been used to enable the communication and enactment of use policies for multimedia content across a broad range of distribution channels and devices. Watermarks are typically embedded substantially imperceptibly in one or more components of a multimedia content, such as in an audio component or a video component, and can be used for a variety of applications such as tamper detection, copy management, content identification, broadcast monitoring, etc.

### SUMMARY OF SELECT EMBODIMENTS

The disclosed embodiments relate to techniques to thwart unauthorized usage of multimedia content. In particular embodiments, systems, devices, methods and computer program products are described that employ a forensic watermark to respond to real-time piracy of broadcast streams. One aspect of the disclosed embodiments, relates to a method for thwarting unauthorized access to a content that includes receiving one or more portions of a content in real-time at a user device, and embedding, at the user device, a particular code in the one or more portions of the real-time content. The particular code associates the received real-time content to the user device and indicates, at least-in-part, that the real-time content is received by the user device. The above method additionally includes receiving further portions of the real-time content with one or more codes incorporated therein, determining, at the user device, whether or not the particular code matches the one or more codes that are incorporated into the further portions of the real-time content. Upon a determination that the particular code matches the one or more codes that are incorporated into the further portions of the real-time content, one or more actions are initiated to thwart further dissemination of the real-time content.

In one exemplary embodiment, the particular code is a random number that is generated by the user device and is not traceable to the user device by other devices or entities. In another exemplary embodiment, the real-time content is received at the user device through one or more of: a broadcast channel, a multi-cast channel, or a uni-cast channel. In still another exemplary embodiment, the one or more code(s) incorporated into the further portions of the real-time content are incorporated into a header portion of the real-time content data packets. For example, the header portion can be a header of an AC3-compressed data packet. In yet another exemplary embodiment, initiating the one or more actions comprises initiating one or more of the following: stopping the playback of the real-time content, providing a warning message as to unauthorized usage of the real-time content, muting an audio portion of the real-time content, or blanking a video portion of the real-time content.

According to another exemplary embodiment, the one or more codes are incorporated into the real-time content by one or more of: multiplexing the code with the further portions of the real-time content, or embedding the codes within the further portions of the real-time content. In another exemplary embodiment, the determination that the particular code matches the one or more codes that are incorporated into the further portions of the real-time content occurs while the real-time content is still being received by the user device, and the one or more actions are carried out to interfere with consumption of the real-time content at the user device. In yet another exemplary embodiment, the above noted method further includes monitoring a communication network to determine whether or not one or more real-time contents disseminated over the communication network include the particular code, and upon a determination that the one or more disseminated real-time contents include the particular code, initiating one or more actions to thwart further dissemination of the real-time content.

Another aspect of the disclosed embodiments relates to a user device that includes a receiver to receive one or more portions of a content in real-time, and an embedder coupled to the receiver to embed a particular code in the one or more portions of the real-time content. The particular code associates the received real-time content to the user device and the receiver also receives further portions of the real-time content with one or more codes incorporated therein. The device also includes a code checker component to determine whether or not the particular code matches the one or more codes that are incorporated into the further portions of the real-time content, and an enforcement module to initiate one or more actions to thwart further dissemination of the real-time content upon a determination that the particular code matches the one or more codes that are incorporated into the further portions of the real-time content.

Another aspect of the disclosed embodiments relates to a computer program product, embodied on one or more non-transitory computer readable media, that includes program code for receiving one or more portions of a content in real-time at a user device, program code for embedding, at the user device, a particular code in the one or more portions of the real-time content, the particular code associating the received real-time content to the user device and program code for receiving further portions of the real-time content with one or more codes incorporated therein. The computer program product also includes program code for, upon a determination that the particular code matches the one or more codes that are incorporated into the further portions of the real-time content, initiating one or more actions to thwart further dissemination of the real-time content.

Another aspect of the disclosed embodiments relates to a user device that includes at least one processor, and a memory comprising processor executable code. The processor executable code when processed by the at least one processor configures the user device to receive one or more portions of a content in real-time, and to embed a particular code in the one or more portions of the real-time content, where the particular code associates the received real-time content to the user device. The processor executable code when processed by the at least one processor also configures the user device to receive further portions of the real-time content with one or more codes incorporated therein, to determine whether or not the particular code matches the one or more codes that are incorporated into the further portions of the real-time content, and upon a determination that the particular code matches the one or more codes that are incorporated into the further portions of the real-time content, initiate one or more actions to thwart further dissemination of the real-time content.

In one exemplary embodiment, the processor executable code when processed by the at least one processor configures the user device to select a random number and to use the random number as part of the particular code for embedding into the one or more portions of the real-time content. In another exemplary embodiment, the user device is configured to receive at the real-time content through one or more of: a broadcast channel, a multi-cast channel, or a uni-cast channel. In yet another exemplary embodiment, the processor executable code when processed by the at least one processor configures the user device to extract the one or more code(s) incorporated into the real-time content from a header portion of the real-time content data packets. In one particular embodiment, the header portion is a header of an AC3-compressed data packet.

According to another exemplary embodiment, the processor executable code when processed by the at least one processor configures the user device to ate the one or more actions that include one or more of the following: stopping the playback of the real-time content, providing a warning message as to unauthorized usage of the real-time content, muting an audio portion of the real-time content, or blanking a video portion of the real-time content. In still another exemplary embodiment, the processor executable code when processed by the at least one processor configures the user device to extract the one or more code(s) incorporated into the further portions of the real-time content through one or more of: de-multiplexing the one or more codes from the further portions of the real-time content, or extracting the one or more codes that are embedded into the further portions of the content as a watermark with a special designation indicative of a previous consumption of the real-time content.

Another aspect of the disclosed embodiments relates to a system that includes a receiver to receive a content in real-time at a user device, and a watermark embedder to embed a particular code in the received real-time content, where the particular code associates the received real-time content to the user device. The system also includes a real-time content monitoring component coupled to a content distribution network to monitor the content distribution network and to obtain a disseminated version of the real-time content. The system further includes a decision logic component to determine whether or not the obtained real-time content includes the particular code. The system additionally includes an inserter, a code checker and an enforcement component. The inserts is configured to, upon a determination by the decision logic component that the real-time content includes the particular code, incorporate the particular code into one or more remaining portions of the real-time content. The code checker component is configured to analyze the real-time content to check for the presence of the particular code in the one or more remaining portions of the real-time content at the user device, and the enforcement component is configured to initiate one or more actions to thwart further dissemination of the real-time content.

Another aspect of the disclosed embodiments relates to a method for thwarting unauthorized access to a content that includes receiving a content in real-time at a user device, and embedding a particular code in the received real-time content by the user device, where the particular code associates the received real-time content to the user device. The method also includes monitoring a communication network to obtain a disseminated version of the real-time content, determining whether or not the obtained real-time content includes the particular code, and upon a determination that the real-time content includes the particular code, incorporating the extracted particular code into one or more remaining portions of the real-time content. The method further includes, upon reception of the one or more remaining portions of the real-time content at the user device, detecting the particular code, and initiating one or more actions to thwart further dissemination of the real-time content.

Another aspect of the disclosed embodiments relates to a computer program product, embodied on one or more non-transitory computer readable media. The computer program produce includes program code for receiving a content in real-time at a user device, and program code for embedding a particular code in the received real-time content by the user device, where the particular code associates the received real-time content to the user device. The computer program product also includes program code for monitoring a communication network to obtain a disseminated version of the real-time content, program code for determining whether or not the obtained real-time content includes the particular code, program code for, upon a determination that the real-time content includes the particular code, incorporating the particular code into one or more remaining portions of the real-time content. The computer program product additionally includes program code for, upon reception of the one or more remaining portions of the real-time content at the user device, detecting the particular code, and program code for, upon the detection of the particular code from the one or more remaining portions of the real-time content, initiating one or more actions to thwart further dissemination of the real-time content.

Another aspect of the disclosed embodiments relates to a method for thwarting unauthorized access to a content. Such a method includes monitoring a communication network to obtain a real-time content, determining whether or not the obtained real-time content includes one or more codes embedded therein, and upon a determination that the real-time content includes one or more embedded codes, incorporating the one or more codes into one or more remaining portions of the real-time content. For a real-time content that has been subjected to such operations, upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

In one exemplary embodiment, incorporating the one or more codes into one or more remaining portions of the real-time content comprises incorporating more than one code. In another exemplary embodiment, the codes incorporated in the remaining portions of the real-time content include a time code that allow the determination as to whether or not the particular code has been used by the user device within a previous time interval of a particular duration.

Another aspect of the disclosed embodiments relates to a system that includes a real-time content monitoring component coupled to a content distribution network to monitor the content distribution network and to obtain a real-time content from the content distribution network. The system also includes a decision logic component coupled to the real-time content monitoring component to determine whether or not the obtained real-time content includes one or more codes embedded therein, and an inserter to incorporate the one or more codes into one or more remaining portions of the real-time content upon a determination that the real-time content includes one or more embedded codes. For a content that has been processed by this system as described above, upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

In one exemplary embodiment, the real-time content monitoring component is configured to monitor a plurality of real-time contents, the decision logic component is configured to determine whether or not the plurality of real-time content include codes embedded therein, and the inserter is configured incorporate more than one code into the remaining portions of each of the plurality of the real-time contents. In another exemplary embodiment, the codes incorporated in the remaining portions of the real-time content include a time code that allow the determination as to whether or not the particular code has been used by the user device within a previous time interval of a particular duration.

Another aspect of the disclosed embodiments relates to a device that includes at least one processor, and a memory comprising processor executable code. The processor executable code when processed by the at least one processor configures the device to monitor a communication network to obtain a real-time content, determine whether or not the obtained real-time content includes one or more codes embedded therein, and upon a determination that the real-time content includes one or more embedded codes, incorporate the one or more codes into one or more remaining portions of the real-time content. Upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

Another aspect of the disclosed embodiments relates to a computer program product, embodied on one or more non-transitory computer readable media, that includes program code for monitoring a communication network to obtain a real-time content, program code for determining whether or not the obtained real-time content includes one or more codes embedded therein. The computer program product also includes program code for, upon a determination that the real-time content includes one or more embedded codes, incorporating the one or more codes into one or more remaining portions of the real-time content, where, upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

### BRIEF DESCRIPTION OF THE DRAWINGS

FIG. 1 illustrates a set of operations that may be carried out to thwart unauthorized access to a real-time content in accordance with an exemplary embodiment.

FIG. 2 illustrates a set of exemplary operations that may be carried out to thwart unauthorized access to a real-time content in accordance with another exemplary embodiment.

FIG. 3 illustrates a set of operations that may be carried out to thwart unauthorized access to a real-time content in accordance with yet another exemplary embodiment.

FIG. 4 illustrates a exemplary system of the disclosed embodiments to thwart unauthorized access to a real-time content.

FIG. 5 illustrates a device within which various disclosed embodiments my be implemented.

### DETAILED DESCRIPTION OF CERTAIN EMBODIMENTS

in the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Live events, such as sport or entertainment events are often broadcast to a subset of customers, such as paying customers in pay-per-view case or subscribers to premium channels of cable or satellite broadcasts. Sometimes broadcast is prevented in an area close to the event venue in order to increase attendance. Often some users capture live broadcasts and stream them over Internet with little delays, making them piracy originators. Then non-subscribers can receive this content for free, or a at a very low cost, typically through some Internet streaming sites. This limits the need for piracy users to pay to watch broadcasts or attend the events. Therefore it is desirable to design a system that would real-time detect such streaming and enforce copyright protection. Sending take-down notices to sites that provide streaming services has proven to be a slow process that does not efficiently or effectively stop this type of piracy.

The disclosed embodiments relate to systems, methods, devices and computer program products that can operate in real-time to thwart unauthorized access to a content. For example, copyright enforcement can be exerted against an unauthorized user or viewer of the real-time content with a delay that is only a small fraction of typical live event duration.

According to an exemplary embodiment, a method for thwarting unauthorized access to real-time content includes the following steps. In this exemplary embodiment, a user device (such as a mobile phone, tablet, a laptop, a computer, a set-top box, a television receiver, and/or the like) receives a real-time content. For example, the content may be received via a broadcast channel, a multi-cast channel, or a uni-cast channel. It is assumed that such a user device is authorized to legitimately receive the real-time content. Next, a user device embeds one or more watermarks into the content prior to outputting it (e.g., for viewing, transmission, etc.), witty substantially distinct codes embedded by each device. These embedded watermarks are sometimes referred to as forensic codes since they identify, correspond to, or otherwise are associated with the user device, a user of the user device, or a transaction that involves the user device.

Next, a monitoring module, such as an Internet monitoring module, accesses suspect streams and extracts the embedded codes. Any audiovisual stream that is available for viewing concurrently with broadcasting of protected content can be considered as a suspect stream and subject to watermark extraction attempt. Alternatively, the streams that are available for viewing concurrently with the protected broadcast contact could be first identified using various automatic content recognition techniques, or even audio and/or visual inspection, and only those that are identified to match the protected content can be sent to the watermark extractor. In the case where all concurrent streams are subject to watermark extraction, it may be necessary to do content recognition after watermark extraction, e.g. in the case when multiple protected contents are simultaneously broadcast and we need to distinguish between them. Note that in some cases, extracted codes may enable content identification, e.g. in a case where the codes are referencing the transaction that enables user's access to the content. In other cases, such as blackout of sporting events in a local area, a separate content identification step may need to be performed after the code extraction.

The monitoring module can, fir example, reside at a monitoring center with access to the Internet and/or other communication networks that allows search and acquisition of streaming content. Upon obtaining such suspect streams and extracting the embedded codes, an inserter incorporates (e.g., concatenates, multiplexes, modulates, etc.) the extracted codes into the real-time content, assuming that content is still being broadcast in real-time. In this context, “incorporation” of the code typically requires less computationally expensive operations than embedding the code. For example, the codes may be placed into a header portion of the real-time content data packets. Although, in some embodiments, incorporation can include re-embedding the detected codes back into the real-time content (e.g., in a different channel or layer of watermark signaling). In some embodiments, the extracted codes can be re-embedded using a special designation (e.g., having a particular preamble or code) that indicates that such a code was a previously-extracted code by a monitoring device.

Upon reception of the remaining portions of the real-time content (or associated streams), the user device checks the code(s) that are incorporated by the inserter into the real-time content. If an incorporated code is a code that the user device has recently embedded in the real-time content, the device enforces an action consistent with a rights holder of the content, such as to stop the playback of audio and/or video content, provide notices on the user device as to unauthorized access to the content, and/or the like.

As noted above, in some example embodiments, the above mentioned user device is a set-top box used by cable or satellite operators. However, the device can be any device or software application that enables user access to protected content.

There are many watermarking techniques that can be used to embed multi-bit messages efficiently, imperceptibly, and robustly. Some example watermarking techniques are described in U.S. Pat. Nos. 8,020,004, 6,912,315, 7,641,282, 6,427,012, 6,683,958, 5,940,135 and 5,937,000, all of which are herein incorporated by reference.

For example, U.S. Pat. No. 8,020,004 describes a technique to enable flexible insertion of forensic watermarks into a digital content signal using a common customization function. The common customization function flexibly employs a range of different marking techniques that are applicable to a wide range of forensic marking schemes. These customization functions are also applicable to pre-processing and post-processing operations that may be necessary for enhancing the security and transparency of the embedded marks, as well as improving the computational efficiency of the marking process. The common customization function supports a well-defined set of operations specific to the task of forensic mark customization that can be carried out with a modest and preferably bounded effort on a wide range of devices. This is accomplished through the use of a generic transformation technique for use as a “customization” step for producing versions of content forensically marked with any of a multiplicity of mark messages.

Another example watermarking technique is described in U.S. Pat. No. 6,912,315, where auxiliary information representing binary or multi-level logical values is embedded into successive segments of an audio content, video content or other content in response to a user request to download the content via an on-line distributor on a computer network such as the Internet. To avoid unnecessary delays in providing the content to the user, the content is pre-processed to provide two sets or copies of the content. For example, one set contains segments with an embedded binary “0”, while the other set contains corresponding segments with an embedded binary “1”. Successive segments are selected from one of the two sets to provide a time-multiplexed composite content that includes an embedded binary data sequence that identifies the user. In another example watermarking technique described in U.S. Pat. No. 7,677,282, a first reduced-scale signal is produced which corresponds to the host content embedded with a first logical value and a second reduced-scale signal corresponding to the host content embedded with a second logical value is also produced. A first set of segments from the first reduced-scale signal my be combined with a second set of segments from the second reduced-scale signal in a pre-defined manner to produce a composite embedded host content. Thus, this technique, reduces the storage and transmission requirements of the watermarking system since only the original content plus two reduced-scale signals are produced and transmitted.

Another exemplary watermark embedding technique is described in U.S. Pat. No. 7,677,282, where a replica of the cover (i.e., host content or a portion of the cover content in a particular domain (time, frequency or space) is generated according to a stego key specifying modification values to specified parameters of the cover content. The replica content is then modified by an auxiliary signal corresponding to the information to be embedded, and inserted back into the cover content. In another exemplary watermark embedding technique, described in U.S. Pat. No. 6,683,958, a distributed signal feature of the cover content in a particular domain (time, frequency or space) is calculated and compared with a set of predefined quantization values corresponding to an information symbol to be encoded. The amount of change required to modify the signal feature to the determined target quantization value is calculated and the cover content is modified accordingly to change the feature value over a predefined interval. In still another exemplary watermark embedding technique, described in U.S. Pat. No. 5,940,135, an autocorrelation function of a host content is modulated according to the value of an auxiliary information signal by adding a host modifying signal to the host content.

Another watermark embedding technique, described in U.S. Pat. No. 5,937,000, provides an example of a spread-spectrum-like watermark embedding technique, where auxiliary data is transported in a primary or host content by hiding the data in the form of colored noise. The colored noise has a spectrum that simulates the spectrum of the primary content. The data to be transported is first converted to a spread spectrum signal. The primary content is analyzed to determine its spectral shape and the same spectral shape is imparted to the spread spectrum signal, which is then combined with the host content for transmission. The spectral shaping can be performed using time domain modeling and synthesis such as linear predictive coding or by using subband coding techniques such as fast Fourier transforms. In this technique, by adjusting the gain of individual spread spectrum signal carrier(s) and the power of the colored noise, the auxiliary information stream(s) can be rendered at a desired level at below or above an interference threshold in the primary host content.

Any one of the above watermark embedding techniques, as well as additional watermark embedding techniques, may be used for embedding messages in a host content as part of the embodiments of the present application.

In some embodiments of the present application, the embedded code identifies the transaction that provides the user rights to access the content, but can additionally include the device ID and a time code. The time code can be relatively coarse, e.g. a count of hours from a reference moment when the system is launched. Furthermore, it is possible to design a system where each device selects a random number and embeds it. This way, the identity of the user device and/or the transaction will not be known to other entities other than the user device. If the random numbers are of sufficient size, say 128 bits, then the chances that two devices will simultaneously select the same random number can be negligibly small. Further, the user device should embed a different random number for each real-time content that it accesses. Using random codes may be preferred if privacy becomes an issue, since the use of random number makes tracing the violating device very difficult.

Internet monitoring for enforcing copyright, protection can be done at least partially in an automatic fashion using watermarking detection or fingerprinting techniques. Typically web crawlers can be used to efficiently and quickly detect watermark presence and extract the embedded codes.

According to the disclosed embodiments, extracted codes are quickly communicated to the inserter, which is located in the communication path between the source of live broadcast signal and the receiver device. In some embodiments, the inserter is located at the very source of the content, while in other embodiments, the inserter is located a point downstream before actual broadcast of the content. Care should be taken that all of the distributed streams carry inserted codes because if one stream is broadcast without inserted codes, it could be a source of Internet retransmission, allowing the content without the code to be retransmitted by many sites and diminish value of the protection.

The extracted codes can be incorporated into the broadcast stream by multiplexing them with the content data. For example, AC3 audio data stream, which is standardized for digital TV broadcasts, has defined an auxiliary data field in each frame, which can be used to carry the extracted codes. In some embodiments, a list of extracted codes is incorporated into the real-time content relatively infrequently, for example every 15 seconds. Since typically a small number of users/user devices are the source of pirated real-time content for the duration of a live broadcast, it is expected that less than 100 such codes will need to be inserted per 15 seconds. If each code takes 128 hits, then the total channel capacity needed to transmit the extracted codes is about 853 bits per second, which is less than 0.3% of the capacity used by a typical AC3 stream. Alternatively, or additionally, the inserter can incorporate the extracted codes in the form of payloads of watermarks embedded into the content.

The inserter may further inspect the codes before incorporating them into the real-time content in order to distinguish those codes that correspond to currently broadcast content from those that correspond to content that was broadcast earlier, saved, and are now being redistributed (e.g., over the Internet). Old codes can be discarded as they are unrelated to the current broadcast. For example, if the extracted codes include a time code, and the time code shows a time lapse of over a threshold, e.g. 2 hours, the code can be considered too old. Also, if the database which is accessible to the inserter shows that the particular code was detected previously more than a predefined time interval ago, e.g. two hours ago, the code can be discarded as old. In some embodiments, after each code extraction, the results of the extraction (e.g., the code value, time of detection, user device ID, transaction ID and/or any other information that is available from, or is applicable to, the extracted codes) is stored at the database. Such a database can be the same as, or different from, a database that contains transaction-related, watermark-related and/or fingerprint-related information that is obtained during a transaction with, or authorization process of, the user device that allowed the user device to receive the real-time content.

Special care needs to be taken to ensure that extracted codes that are incorporated into the remaining portions of the real-time content are not removed or damaged during content distribution and broadcast, for example when transcoding is done to accommodate the capacity of a particular distribution channel or the resolution of a rendering device. Assuming that nobody in the distribution chain has an interest to remove the codes, it should not be difficult to monitor all the processing stages in the distribution chain and ensure safe transmission of the incorporated extracted codes. For example, the above mentioned AC3 audio data stream is typically created at the very source of the content, and is never irreversibly changed or transcoded until it reaches a destination set-top box. Alternatively, if the extracted codes are carried by watermarks, care must be taken that typical signal processing operations in the distribution channels do not appreciably interfere with subsequent extraction of the embedded codes.

A user device, as part of its normal operation, should monitor the extracted codes that are incorporated into the content or are embedded with a designation identifying them as having been detected by a monitoring device. If the monitoring reveals a code that was previously embedded by the device itself within less than a predetermined time interval (e.g. two hours), the user device should initiate one or more actions to thwart unauthorized dissemination of the real-time content. For example, the user of the device can be notified that Internet redistribution of this content is not allowed, and device output may be disabled for a predefined period of time.

The functionalities needed for carrying out the above noted operations, detection of codes incorporated or embedded in the real-time content, embedding of watermarks into a received content, decision logic for initiating one or more actions in response to detection of matching of codes, etc., can be all implemented within the same module, such as the AC3 decoder. For instance, watermark embedding can be done by modifying frequency bins in the MDCT domain, accessing auxiliary data field is a standard function of decoders, and if its embedded code is found, enforcement can be done by muting the audio for a predefined period of time, e.g. 15 seconds. Similarly code insertion/incorporation into the real-time content can be done by the AC3 encoder. This way, only a small number of modules that are under the control of a single entity, e.g. perceptual codec designers, are changed, which simplifies the implementation.

One of the features of the disclosed embodiments is that they allow control and/or enforcement of content protection at the source of live broadcast, without necessarily relying on content distributors which may not have the ability to cut off the feed of individual recipients.

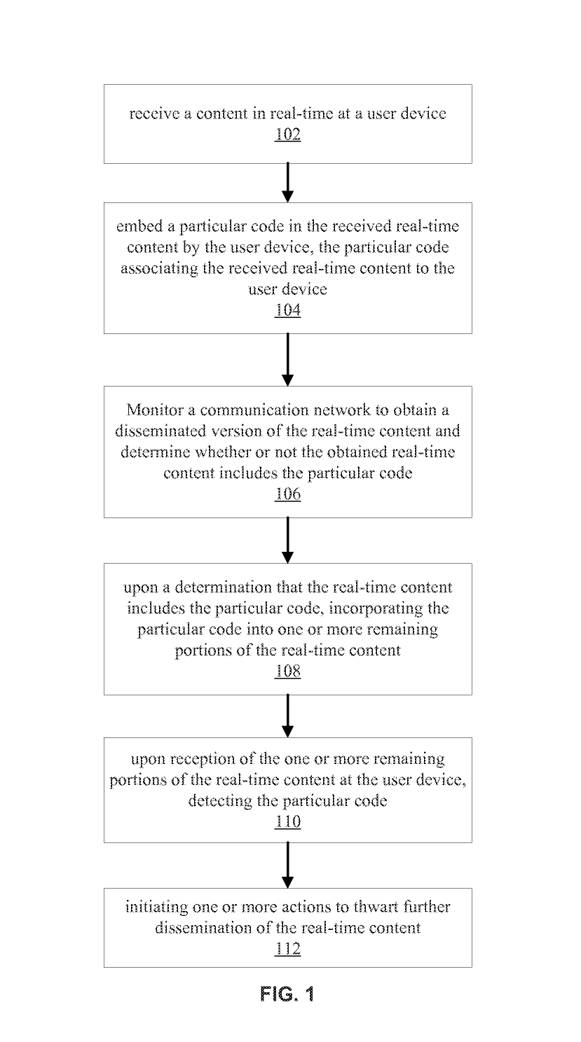

FIG. 1 illustrates a set of operations that may be carried out to thwart unauthorized access to a real-time content in accordance with an exemplary embodiment. At 102, a content is received in real-time at a user device. At 104, a particular code is embedded in the received real-time content by the user device. The particular code associates the received real-time content to the user device. At 106, a communication network is monitored to obtain a disseminated version of the real-time content and to determine whether or not the obtained real-time content includes the particular code. At 108, upon a determination that the real-time content includes the particular code, the particular code is incorporated into one or more remaining portions of the real-time content. At 110, upon reception of the one or more remaining portions of the real-time content at the user device, the particular code is detected, and at 112, one or more actions to thwart further dissemination of the real-time content is initiated.

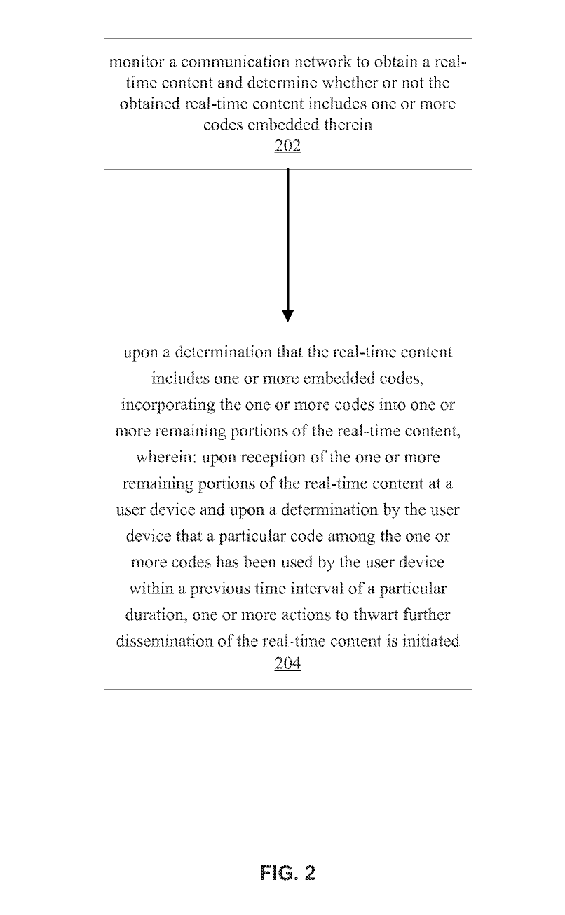

FIG. 2 illustrates a set of exemplary operations that may be carried out to thwart unauthorized access to a real-time content in accordance with an exemplary embodiment. The operations that are illustrated in FIG. 2 may be carried out outside of the user device at, for example, one or more of a monitoring center, a distribution center, or at a content broadcaster location. At 202, a communication network is monitored to obtain a real-time content and to determine whether or not the obtained real-time content includes one or more codes embedded therein. At 204, upon a determination that the real-time content includes one or more embedded codes, the one or more codes are incorporated into one or more remaining portions of the real-time content. Upon reception of such remaining portion(s) of the real-time content at a user device and upon a determination by the user device that a particular code among the one or more codes has been used by the user device within a previous time interval of a particular duration, one or more actions to thwart further dissemination of the real-time content is initiated.

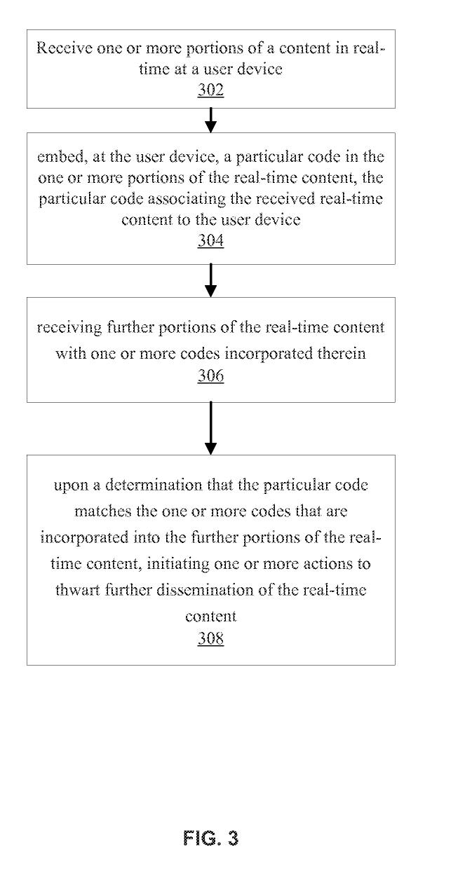

FIG. 3 illustrates a set of operations that may be carried out to thwart unauthorized access to a real-time content in accordance with an exemplary embodiment. The operations that are illustrated in RIG. 3 may be carried out at a user device, such as cable set-top box, a satellite receiver box, a television set, smart phone, a game counsel, a tablet and/or the like. At 302, one or more portions of a content is received in real-time at a user device. At 304, a particular code in the one or more portions of the real-time content is embedded at the user device, where the particular code associates the received real-time content to the user device. At 306, further portions of the real-time content with one or more codes incorporated therein are received. At 308, upon a determination that the particular code matches the one or more codes that are incorporated into the further portions of the real-time content, one or more actions to thwart further dissemination of the real-time content is initiated.

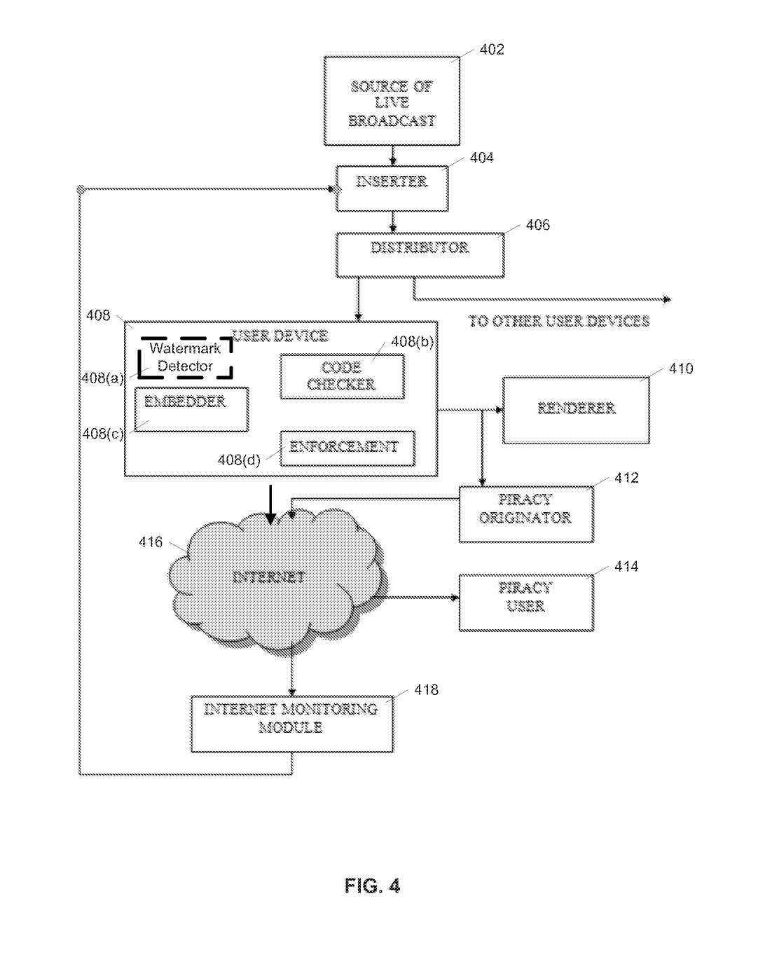

FIG. 4 illustrates a exemplary system of the disclosed embodiments to thwart unauthorized access to a real-time content. The Source of Live Broadcast 402 provides the real-time content that is distributed by the Distributor 406 to one or more user devices 408. A user device 408 can include a watermark embedder 408 (c) configured to embed one or more codes into the real-time content. The user device 408 further includes decision logic components (not shown) or processing elements (not shown) that allows the user device 408 to check whether or not codes incorporated into the received real-time content by the inserter 404 have been recently used by the user device 408. The enforcement component 408 (d) in the user device 408 can initiate one or more actions to thwart unauthorized access to the content. For example, the enforcement component 408 (d) can stop the flow of video/audio data to the renderer 410 (e.g., mute the audio or blank the video signal). The user device 408 may optionally be equipped with a watermark detector 408 (a) (in embodiments where the inserter embeds the detected codes as watermarks into the real-time content) to detect the codes that are embedded in the received real-time content. The pirated content may be directly communicated to a distribution network 416 (such as the Internet), or may be first provided to another entity that operates as the “piracy originator” 412 which then disseminates the content. A piracy user 414 may then obtain the disseminated content from the distribution network 416.

Still referring to FIG. 4, the Monitoring Module 418 in this exemplary embodiment monitors the distribution network 416 (e.g., the Internet) to obtain potential pirated real-time content, and to determine whether or not such content includes embedded watermarks. The monitoring module 418 can then signal the detected codes to the inserter 404 to be incorporated into the remaining portions of the real-time content. The inserter 404 and/or the monitoring module 418 may also include decision logic components that are configured to determine whether or not the detected codes would be of interest (e.g., if the associated time stamps indicate that the real-time content is still being broadcast).

As shown in, for example, FIG. 4 of the present application, the described systems include various components or modules can be implemented as hardware, software, or combinations thereof. For example, a hardware implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

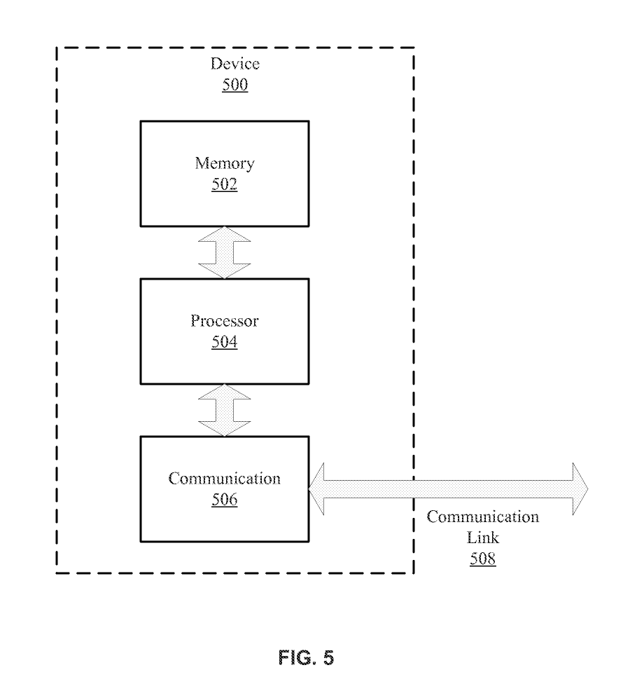

Certain aspects of the disclosed embodiments can be implemented as a device that includes a processor, and a memory comprising processor executable code. The processor executable code, when executed by the processor, configures the device to perform any one of and/or all operations that are described in the present application. For example, FIG. 5 illustrates a block diagram of a device 500 within which various disclosed embodiments may be implemented. The device 500 comprises at least one processor 504 and/or controller, at least one memory 502 unit that is in communication with the processor 504, and at least one communication unit 505 that enables the exchange of data and information, directly or indirectly, through the communication link 508 with other entities, devices, databases and networks. The communication unit 506 may provide wired and/or wireless communication capabilities in accordance with one or more communication protocols, and therefore it may comprise the proper transmitter/receiver, antennas, circuitry and ports, as well the encoding/decoding capabilities that may be necessary for proper transmission and/or reception of data and other information. The exemplary device 500 of FIG. 5 may be integrated as part of any of the devices that are shown in FIG. 4.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method for thwarting unauthorized access to a content, comprising:
receiving one or more portions of a content in real-time at a user device;
embedding, at the user device, a particular code in the one or more portions of the real-time content, the particular code associating the received real-time content to the user device and indicating at least-in-part that the real-time content is received by the user device;
receiving further portions of the real-time content with one or more codes incorporated therein;
determining, at the user device, whether or not the particular code matches the one or more codes that are incorporated into the further portions of the real-time content; and
upon a determination that the particular code matches the one or more codes that are incorporated into the further portions of the real-time content, initiating one or more actions to thwart further dissemination of the real-time content.

2. The method of claim 1, wherein the particular code is a random number that is generated by the user device and is not traceable to the user device by other devices or entities.

3. The method of claim 1, wherein the real-time content is received at the user device through one or more of: a broadcast channel, a multi-cast channel, or a uni-cast channel.

4. The method claim 1, wherein the one or more code(s) incorporated into the further portions of real-time content are incorporated into a header portion of the real-time content data packets.

5. The method of claim 4, wherein the header portion is a header of an AC3-compressed data packet.

6. The method of claim 1, wherein initiating the one or more actions comprises initiating one or more of the following:
stopping the playback of the real-time content;
providing a warning message as to unauthorized usage of the real-time content;
muting an audio portion of the real-time content; or
blanking a video portion of the real-time content.

7. The method of claim 1, wherein the one or more codes are incorporated into the real-time content by one or more of: multiplexing the code with the further portions of the real-time content, or embedding the codes in the further portions of the real-time content.

8. The method of claim 1, wherein the determination that the particular code matches the one or more codes that are incorporated into the further portions of the real-time content occurs while the real-time content is still being received by the user device, and the one or more actions are carried out to interfere with consumption of the real-time content at the user device.

9. The method of claim 1, further comprising:
monitoring a communication network to determine whether or not one or more real-time contents disseminated over the communication network include the particular code; and
upon a determination that the one or more disseminated real-time contents include the particular code, initiating one or more actions to thwart further dissemination of the real-time content.

10. A user device, comprising:
a receiver to receive one or more portions of a content in real-time;
embedder coupled to the receiver to embed a particular code in the one or more portions of the real-time content, the particular code associating the received real-time content to the user device, the receiver also to receive further portions of the real-time content with one or more codes incorporated therein;
a code checker component to determine whether or not the particular code matches the one or more codes that are incorporated into the further portions of the real-time content; and
an enforcement module to initiate one or more actions to thwart further dissemination of the real-time content upon a determination that the particular code matches the one or more codes that are incorporated into the further portions of the real-time content.

11. A computer program product, embodied on one or more non-transitory computer readable media, comprising:
program code for receiving one or more portions of a content in real-time at a user device;
program code for embedding, at the user device, a particular code in the one or more portions of the real-time content, the particular code associating the received real-time content to the user device;
program code for receiving further portions of the real-time content with one or more codes incorporated therein; and
program code for, upon a determination that the particular code matches the one or more codes that are incorporated into the further portions of the real-time content, initiating one or more actions to thwart further dissemination of the real-time content.

12. A user device comprising:
at least one processor; and
a memory comprising processor executable code, the processor executable code when processed by the at least one processor configures the user device to:
receive one or more portions of a content in real-time;
embed a particular code in the one or more portions of the real-time content, the particular code associating the received real-time content to the user device,
receive further portions of the real-time content with one or more codes incorporated therein;
determine whether or not the particular code matches the one or more codes that are incorporated into the further portions of the real-time content; and
upon a determination that the particular code matches the one or more codes that that, are incorporated into the further portions of the real-time content, initiate one or more actions to thwart further dissemination of the real-time content.

13. The user device of claim 12, wherein the processor executable code when processed by the at least one processor configures the user device to select a random number and to use the random number as part of the particular code for embedding into the one or more portions of the real-time content.

14. The user device of claim 12, configured to receive at the real-time content through one or more of a broadcast channel, a multi-cast channel, or a uni-cast channel.

15. The device of claim 12, wherein the processor executable code when processed by the at least one processor configures the user device to extract the one or more code(s) incorporated into the further portions of the real-time content from a header portion of the real-time content data packets.

16. The device of claim 15, wherein the header portion is a header of an AC3-compressed data packet.

17. The device of claim 12, the processor executable code when processed by the at least one processor configures the user device to initiate the one or more actions that include one or more of the following:
stopping the playback of the real-time content;
providing a warning message as to unauthorized usage of the real-time content;
muting an audio portion of the real-time content; or
blanking a video portion of the real-time content.

18. The device of claim 12, wherein the processor executable code when processed by the at least one processor configures the user device to extract the one or more code(s) incorporated into the further portions of the real-time content through one or more of de-multiplexing the one or more codes from the further portions of the real-time content, or extracting the one or more codes that are embedded into the further portions of the content as a watermark with a special designation indicative of a previous consumption of the real-time content.

19. A system comprising:
a receiver to receive a content in real-time at a user device;
a watermark embedder to embed a particular code in the received real-time content, the particular code associating the received real-time content to the user device;
a real-time content monitoring component coupled to a content distribution network to monitor the content distribution network to obtain a disseminated version of the real-time content;
a decision logic component to determine whether or not the obtained real-time content includes the particular code;
an inserter configured to, upon a determination by the decision logic component that the real-time content includes the particular code, incorporate the particular code into one or more remaining portions of the real-time content;
a code checker component to analyze the real-time content to check for the presence of the particular code in the one or more remaining portions of the real-time content at the user device; and
an enforcement component configured to initiate one or more actions to thwart further dissemination of the real-time content.

20. A method for thwarting unauthorized access to a content, comprising:
receiving a content in real-time at a user device;
embedding a particular code in the received real-time content by the user device, the particular code associating the received real-time content to the user device;
monitoring a communication network to obtain a disseminated version of the real-time content;
determining whether or not the obtained real-time content includes the particular code;
upon a determination that the real-time content includes the particular code, incorporating the extracted particular code into one or more remaining portions of the real-time content;
upon reception of the one or more remaining portions of the real-time content at the user device, detecting the particular code; and
initialing one or more actions to thwart further dissemination of the real-time content.

21. A computer program product, embodied on one or more non-transitory computer readable media, comprising:
program code for receiving a content in real-time at a user device;
program code for embedding a particular code in the received real-time content by the user device, the particular code associating the received real-time content to the user device;
program code for monitoring a communication network to obtain a disseminated version of the real-time content;
program code for determining whether or not the obtained real-time content includes the particular code;
program code for, upon a determination that the real-time content includes the particular code, incorporating the particular code into one or more remaining portions of the real-time content;
program code for, upon reception of the one or more remaining portions of the real-time content at the user device, detecting the particular code; and
program code for, upon the detection of the particular code from the one or more remaining portions of the real-time content, initiating one or more actions to thwart further dissemination of the real-time content.

22. A method for thwarting unauthorized access to a content, comprising:
monitoring a communication network to obtain a real-time content;
determining whether or not the obtained real-time content includes one or more codes embedded therein; and
upon a determination that the real-time content includes one or more embedded codes, incorporating the one or more codes into one or more remaining portions of the real-time content, wherein:
upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

23. The method of claim 22, wherein incorporating the one or more codes into one or more remaining portions of the real-time content comprises incorporating more than one code.

24. The method of claim 22, wherein the codes incorporated in the remaining portions of the real-time content include a time code that allow the determination as to whether or not the particular code has been used by the user device within a previous time interval of a particular duration.

25. A system, comprising:
a real-time content monitoring component coupled to a content distribution network to monitor the content distribution network and to obtain a teal-time content from the content distribution network;
a decision logic component coupled to the real-time content monitoring component to determine whether or not the obtained real-time content includes one or more codes embedded therein; and
an inserter to incorporate the one or more codes into one or more remaining portions of the real-time content upon a determination that the real-time content includes one or more embedded codes, wherein:
upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

26. The system of claim 25, wherein the real-time content monitoring component is configured to monitor a plurality of real-time contents, the decision logic component is configured to determine whether or not the plurality of real-time content include codes embedded therein, and the inserter is configured incorporate more than one code into the remaining portions of each of the plurality of the real-time contents.

27. The system of claim 25, wherein the codes incorporated in the remaining portions of the real-time content include a time code that allow the determination as to whether or not the particular code has been used by the user device within a previous time interval of a particular duration.

28. A device comprising:
at least one processor; and
a memory comprising processor executable code, the processor executable code when processed by the at least one processor configures the device to:
monitor a communication network to obtain a real-time content;
determine whether or not the obtained real-time content includes one or more codes embedded therein; and
upon a determination that the real-time content includes one or more embedded codes, incorporate the one or more codes into one or more remaining portions of the real-time content, wherein:
upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.

29. A computer program product, embodied on one or more non-transitory computer readable media, comprising:
program code for monitoring a communication network to obtain a real-time content;
program code for determining whether or not the obtained real-time content includes one or more codes embedded therein; and
program code for, upon a determination that the real-time content includes one or more embedded codes, incorporating the one or more codes into one or more remaining portions of the real-time content, wherein:
upon reception of the one or more remaining portions of the real-time content at a user device and upon a determination by the user device that a particular code among the one or more codes has been used by the user device within a previous time interval of a particular duration, one or more actions to thwart further dissemination of the real-time content is initiated.
